(19) United States
(12) Patent Application Publication
(10) Pub. No.: US 2007/0111801 A1
(43) Pub. Date: May 17, 2007

(54) Method, apparatus and system for transmitting and receiving media data

(75) Inventors: George Haber, Mountain View, CA (US); Tarun Kripalani, Los Altos, CA (US); Yakov Levy, Sunnyvale, CA (US); Michael K. Harris, San Jose, CA (US); Michael Genossar, Modi'in (IL); Eran Igler, Tel Aviv (IL); Avner Taieb, Petach Tikva (IL); Florin Calin, Hod Hasharon (IL)

Correspondence Address: Eitan Law Group;C/O LandonIP Inc., 1700 Diagonal Road, Suite 450, Alexandria, VA, 22314, US

(73) Assignee: Adimos Systems Ltd., Kfar Saba (IL)

(21) Appl. No.: 11/411,978

(22) Filed: Apr. 26, 2006

Related U.S. Application Data
(60) Provisional application No. 60/735,377, filed on Nov. 11, 2005.

(51) Int. Cl. A63F 13/00

(52) U.S. Cl. 463/43

(57) ABSTRACT

There is provided, in accordance with some embodiments of the present invention, an apparatus, a method and a system for enabling at least a first device and a second device to establish communication and transmission of media and/or gaming data. The present invention is a method, apparatus and system for transmitting media and/or gaming (“media/gaming”) data from a mobile media and/or gaming device (“mobile media/gaming device”) to one or more presentation (e.g. audio and/or video) devices.

### FIELD OF THE INVENTION

The present invention generally relates to the field of communication. More specifically, the present invention relates to the wireless transmission of content bearing data and/or presentation data from a portable device to a presentation device.

### BACKGROUND

Over the past three decades, the popularity of mobile media devices has increased dramatically. Originally referred to as a “personal stereo”, the first commercial personal stereo was called “Sony Walkman” and was released in 1979. The device played an audio cassette, which audio cassette usually stored music, and it quickly became a world wide commercial success. Sony's personal stereo product was quickly cloned by competitors, and various cassette playing mobile media devices became the most widely used devices for listening to music while traveling or exercising.

The ever evolving research for developing new methods of media storage did not skip the huge market of portable media devices and new portable media devices constantly appeared in the market, an exemplary list of such media storage method may consist of Audio cassettes, Compact Disc (CD's), Mini Disc (MD's) and finally MP3/other types of media files stored on a Non Volatile Memory array.

The constant improvement and development of new forms of media (e.g. sound, images, video, interactive multi-media content, etc.) led to the development of new portable media players that enable the usage and presentation of various media types. Many present-day media devices or players support not only music, but also support the presentation of video files and interactive gaming applications. Common to most media devices is a non-volatile memory, a digital controller, various decoders which may either be part of the digital controller or functionally connected thereto, and audio/video out components (erg. speakers and video display). Typically, content to be played on the device is stored in an encoded format on the device's non-volatile memory or on a connectable non-volatile memory device, and decoded by a decoder during playing. When the device is a gaming device, executable code for generating one or more games is stored either on the device's non-volatile memory or on a non-volatile memory device connectable with the gaming device, and the controller and/or an associated gaming processor may execute the code during playing of the one or more games.

Today, most homes, businesses and numerous other premises in the developed world have media, gaming and presentation devices capable of storing, receiving and presenting content in various format and media types. Today's modern home, office or home-office usually contains at least one television, and mostly likely will also include a computer, a stereo, a DVD player, and a proprietary content provider's (e.g. cable or wireless content provider) decoder box. The terms “Home Theater”, “Home Entertainment Center” or “Media Center” have been coined to designate a set of devices or even complex media presentation systems for the presentation of content to persons within a home or office.

Since most mobile media/gaming devices are characterized by small presentation components, such as small display screen and/or low fidelity speakers, it is from time-to-time desirable to be able to present content stored and/or played on a mobile media device through a larger presentation device, for example such as video monitor or speakers which is part of a home/office media center. Interconnection between various media playing and presentation devices is an issue which has been addressed by various means including electrical wiring, optical fiber and most recently wireless (e.g. Radio Frequency) transceivers. Wireless transceivers, using various protocols and transmission methodologies (e.g. Bluetooth and WiFi), have been successful in interconnecting various devices in the home and office, but have thus far failed to provide for streaming of multimedia content from a mobile media/gaming device to another presentation device substantially in real-time.

Data used to drive audio and video components of a media device, presentation data, is typically in a very different format than that of the stored media or gaming data files used to generate the presentation data. Whereas stored media/gaming content is typically in a highly compressed/encoded format which is not presentable without decoding or processing, presentation data typically requires only conversion from the digital to analog domains before it may be applied to one or more video and/or audio transducers whose output may be perceived by a person.

As the number and complexity of media devices and systems is growing, so is the need and complexity of interconnecting these devices. Since many devices may present the media files stored on a portable media device (e.g. a TV screen may present video data stored on an iPOD), the need for means to establish efficient, reliable and high quality connections or networks of connections between portable media/gaming players and various larger presentation devices is growing. There is, therefore, a need for improved systems and methods of transmission of stored and/or presentation data from mobile media/gaming devices to presentation devices via wireless (e.g. RF) data links.

### SUMMARY OF THE INVENTION

There is provided, in accordance with some embodiments of the present invention, an apparatus, a method and a system for enabling at least a first device and a second device to establish communication and transmission of media and/or gaming data. The present invention is a method, apparatus and system for transmitting media and/or gaming (“media/gaming”) data from a mobile media and/or gaming device (“mobile media/gaming device”) to one or more presentation (e.g. audio and/or video) devices As part of some embodiments of the present invention, there may be provided a media data transmitter and/or media data transceiver. The media data transmitter and/or media data transceiver may either be integral with the mobile media/gaming device, or according to further embodiments of the present invention, the transmitter and/or transceiver may be integral with a cradle adapted to receive the mobile media/gaming device.

According to some embodiments of the present invention, the media transmitter/transceiver may be adapted to transmit content bearing data to a media receiver functionally associated with a presentation device. The content bearing data may be a compressed media file stored on a mobile media device's non-volatile memory, a video/audio stream generated by a decoder on the media device, or a video/audio stream generated by a game engine or game related processor on a mobile gaming device. For purposes of this application, any of the above mentioned content bearing data, or any other data types which may be transmitted, received and presented in accordance with any aspects of the present invention, may be referred to as: (1) content bearing data, (2) content bearing data stream, (3) media data stream, or (4) any other term which would be understood by one or ordinary skill in the art at the time the present application is filed.

According to some embodiments of the present invention, the media transmitter and/or transceiver may include a variable rate encoder and/or a variable rate transrater. A Transrater is a device that receives an encoded media data stream at one bit rate, and processes it to create an encoded media data stream at a second bit rate. Typically the second bit rate is equal or lower to the first bit rate.

A transmission channel quality assessment module may cause the variable rate encoder and/or transrater to encode a media/gaming related data stream using a compression level having an inverse correlation to the transmission channel quality of the channel over which the media transmitter and/or transceiver transmits, wherein channel quality may be at least partially characterized by: (1) a Signal-To-Noise ratio associated with the transmission channel, and (2) a packet error rate associated with the transmission channel. According to some embodiments of the present invention, the encoder and/or transrater may add a time-stamp to the encoded data.

According to further embodiments of the present invention, a packetizer may packetize the encoded data. The packetizer may packetize the encoded data into one or more packets whose size may have an inverse correlation to a jitter level at a media receiver. Additionally, the packetizer may intermittently produce one or more high priority data packet(s) whose primary payload is a time-stamp, and which time-stamp carrying packet(s) may include little or no content bearing data. High priority packet(s) with the time-stamp payload may be used by a media receiver to estimate a clock rate of the media stream entering the media transmitter and to generate a clock signal at the receiver corresponding to the estimated rate (i.e. reconstruct the media stream clock).

According to some embodiments of the present invention, the media transmitter may include a transmit buffer (e.g. First In First Out—“FIFO”) to temporarily store one or more packets before the one or more packets are transmitted by a RF transmitting unit (e.g. a WiFi Radio, a Bluetooth Radio, etc.). According to further embodiments of the present invention, the buffer may reduce the rate at which it provides packets to the RF transmitting unit when a receiver buffer assessment unit, which receives receiver buffer size information via a back channel, determines and indicates that a buffer on the Media Receiver is storing a volume of data exceeding some capacity level of the receive buffer (e.g. 70% of the buffers fully data storage capacity).

The transmit buffer may also store for some predefined period of time packets which have already been transmitted by the RF transmit unit. According to these embodiments of the present invention, the predefined period of time may be of a slightly greater duration than a time-out period defined by an RF receiver to which the packet is to be transmitted. Should the transmit buffer receive an indication from the RF receiver that the RF receiver has not received a specific packet within the predefined time-out period (i.e. either does not receive an “Acknowledged Signal” (“ACK”) or receives a “Not Acknowledged Signal” (“NACK”) from the RF receiver), the transmit buffer may resubmit the specific non-received packet to the RF transmit unit for retransmission.

According to some embodiments of the present invention, the media transmitter/transceiver may not be integral with the mobile media/gaming device, but may reside in a cradle adapted to receive the mobile media/gaming device According to some embodiments of the present invention, the cradle may include one or more connectors to connect with one or more signal lines of the media/gaming device. According to some embodiments of the present invention, through one or more connectors, the cradle may receive digital media/gaming data from the media/gaming device. According to yet further embodiments of the present invention, through the connectors, the cradle may receive analog data and may convert the analog data into digital data prior to providing the data to the media transmitter and/or transceiver unit.

According to some embodiments of the present invention, the cradle may include a power supply for the mobile media/gaming device and the media transmitter/transceiver may be integral with the mobile media/gaming device. In accordance with such embodiments, when the mobile media/device is cradled and receiving power via the cradle, the media transmitter/transceiver may operate at a relatively higher transmit power level than when the mobile media/gaming device in not cradled and/or receiving power from an external power supply.

A media receiver or media transceiver functionally associated with a presentation device may receive media related data transmitted by the media transmitter or transceiver functionally associated with the mobile media/gaming device. The media receiver/transceiver may include a RF receiver unit, a receiver buffer, a time-stamp reader, a clock recovery unit and a jitter assessment unit. The clock recovery unit may derive a clock rate and may generate a clock signal associated with the media/content bearing data stream based on several factors including. (1) rate of packet arrival to the buffer, (2) timestamps on or within the media bearing packets, and (3) timestamps on or within the priority packets which may not include media data.

Based on information derived from the receive buffer and/or information derived from data within the received packets, a jitter assessment module may estimate a jitter level value associated with the receipt of media bearing data packets. According to some embodiments of the present invention, the jitter assessment module may intermittently calculate the derivative of the rate of packet arrival (i.e. the change in the rate at which packets arrive at media receiver). A jitter level value relating to a given period of time (e.g. 15 to 60 seconds) may be directly correlated with the derivative of the rate of packet arrivals over the given period of time.

According to some embodiments of the present invention, a jitter level value may be transmitted from the media receiver to the media transmitter, where the jitter level value may have an impact on the following operational parameters of the media transmitter: (1) encoding and/or transrating level, (2) size of the packets into which the encoded media data is packetized, and (3) rate at which packets are moved from the transmit buffer to the RF transmission unit.

According to some embodiments, the jitter level value may also be used by the media receiver to adjust the rates at which packets are moved from the receiver buffer to the depacketizer. The jitter level value may also impact the rate at which the decoder operates to reproduce the media data stream. For example, a high jitter value may result in the selection of a slower clock rate, which slower clock rate may help avoid breaks in the reproduced media data stream.

According to some embodiments of the present invention, a media transmitter/transceiver may engage in multiple communication sessions simultaneously. For Example, the media transmitter/transceiver may concurrently stream a media stream to a first media receiver/transceiver connected to a presentation device while receiving data (media file or executable code) from a second device (e.g. a computer acting as a server). This multiple concurrent communication session feature is supported by several wireless communication standards, including WiFi, each of which standards may be utilized in accordance with various embodiments of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows an illustration of a mobile media/gaming device transmitting to a presentation device content bearing data through an integrated media transceiver, in according with some embodiments of the present invention;

FIG. 1B shows an illustration of a mobile media/gaming device transmitting to a presentation device content bearing data through a media transceiver integrated into a cradle within which the mobile device is docked, in according with some embodiments of the present invention;

FIG. 2A shows a functional block diagram of mobile media/game device having an integrated media transmitter/transceiver in accordance with some embodiments of the present invention;

FIG. 2B shows a functional block diagram of mobile media/game device connectable with a cradle having an integrated media transceiver in accordance with some embodiments of the present invention;

FIG. 3A shows a functional block diagram and signal flow of mobile media device including a media transceiver, where the media transceiver may transmit either stored data or presentation data generated by a decoder, in accordance with some embodiments of the present invention;

FIG. 3B shows a functional block diagram and signal flow of a mobile gaming device including a media transceiver, where the media transceiver may transmit presentation data generated by a gaming engine or processor, in accordance with some embodiments of the present invention;

FIG. 4A shows a functional block diagram and signal flow of a media transceiver according to some embodiments of the present invention;

FIG. 4B shows a functional block diagram and signal flow of a media receiver according to some embodiments of the present invention;

FIG. 5A shows a flow chart including steps implemented by a media transceiver in accordance with some embodiments of the present invention; and

FIG. 5B shows a flow chart including steps implemented by a media receiver in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is provided, in accordance with some embodiments of the present invention, an apparatus, a method and a system for enabling at least a first device and a second device to establish communication and transmission of media and/or gaming data. The present invention is a method, apparatus and system for transmitting media and/or gaming (“media/gaming”) data from a mobile media and/or gaming device (“mobile media/gaming device”) to one or more presentation (e.g. audio and/or video) devices. As part of some embodiments of the present invention, there may be provided a media data transmitter and/or media data transceiver. The media data transmitter and/or media data transceiver may either be integral with the mobile media/gaming device, or according to further embodiments of the present invention, the transmitter and/or transceiver may be integral with a cradle adapted to receive the mobile media/gaming device.

According to some embodiments of the present invention, the media transmitter/transceiver may be adapted to transmit content bearing data to a media receiver functionally associated with a presentation device. The content bearing data may be a compressed media file stored on a mobile media device's non-volatile memory, a video/audio stream generated by a decoder on the media device, or a video/audio stream generated by a game engine or game related processor on a mobile gaming device. For purposes of this application, any of the above mentioned content bearing data, or any other data types which may be transmitted, received and presented in accordance with any aspects of the present invention, may be referred to as: (1) content bearing data, (2) content bearing data stream, (3) media data stream, or (4) any other term which would be understood by one or ordinary skill in the art at the time the present application is filed.

According to some embodiments of the present invention, the media transmitter and/or transceiver may include a variable rate encoder and/or a variable rate transrater. A Transrater is a device that receives an encoded media data stream at one bit rate, and processes it to create an encoded media data stream at a second bit rate. Typically the second bit rate is equal or lower to the first bit rate. A transmission channel quality assessment module may cause the variable rate encoder and/or transrater to encode a media/gaming related data stream using a compression level having an inverse correlation to the transmission channel quality of the channel over which the media transmitter and/or transceiver transmits, wherein channel quality may be at least partially characterized by: (1) a Signal-To-Noise ratio associated with the transmission channel, and (2) a packet error rate associated with the transmission channel. According to some embodiments of the present invention, the encoder and/or transrater may add a time-stamp to the encoded data.

According to further embodiments of the present invention, a packetizer may packetize the encoded data. The packetizer may packetize the encoded data into one or more packets whose size may have an inverse correlation to a jitter level at a media receiver. Additionally, the packetizer may intermittently produce one or more high priority data packet(s) whose primary payload is a time-stamp, and which time-stamp carrying packet(s) may include little or no content bearing data. High priority packet(s) with the time-stamp payload may be used by a media receiver to estimate a clock rate of the media stream entering the media transmitter and to generate a clock signal at the receiver corresponding to the estimated rate (i.e. reconstruct the media stream clock).

According to some embodiments of the present invention, the media transmitter may include a transmit buffer (e.g. First In First Out—“FIFO”) to temporarily store one or more packets before the one or more packets are transmitted by a RF transmitting unit (e.g. a WiFi Radio, a Bluetooth Radio, etc.). According to further embodiments of the present invention, the buffer may reduce the rate at which it provides packets to the RF transmitting unit when a receiver buffer assessment unit, which receives receiver buffer size information via a back channel, determines and indicates that a buffer on the Media Receiver is storing a volume of data exceeding some capacity level of the receive buffer (e.g. 70% of the buffers fully data storage capacity).

The transmit buffer may also store for some predefined period of time packets which have already been transmitted by the RF transmit unit. According to these embodiments of the present invention, the predefined period of time may be of a slightly greater duration than a time-out period defined by an RF receiver to which the packet is to be transmitted. Should the transmit buffer receive an indication from the RF receiver that the RF receiver has not received a specific packet within the predefined time-out period (i.e. either does not receive an “Acknowledged Signal” (“ACK”) or receives a “Not Acknowledged Signal” (“NACK”) from the RF receiver), the transmit buffer may resubmit the specific non-received packet to the RF transmit unit for retransmission.

According to some embodiments of the present invention, the media transmitter/transceiver may not be integral with the mobile media/gaming device, but may reside in a cradle adapted to receive the mobile media/gaming device. According to some embodiments of the present invention, the cradle may include one or more connectors to connect with one or more signal lines of the media/gaming device. According to some embodiments of the present invention, through one or more connectors, the cradle may receive digital media/gaming data from the media/gaming device. According to yet further embodiments of the present invention, through the connectors, the cradle may receive analog data and may convert the analog data into digital data prior to providing the data to the media transmitter and/or transceiver unit.

According to some embodiments of the present invention, the cradle may include a power supply for the mobile media/gaming device and the media transmitter/transceiver may be integral with the mobile media/gaming device. In accordance with such embodiments, when the mobile media/device is cradled and receiving power via the cradle, the media transmitter/transceiver may operate at a relatively higher transmit power level than when the mobile media/gaming device in not cradled and/or receiving power from an external power supply.

A media receiver or media transceiver functionally associated with a presentation device may receive media related data transmitted by the media transmitter or transceiver functionally associated with the mobile media/gaming device. The media receiver/transceiver may include a RF receiver unit, a receiver buffer, a time-stamp reader, a clock recovery unit and a jitter assessment unit. The clock recovery unit may derive a clock rate and may generate a clock signal associated the media content bearing data stream based on several factors including,: (1) rate of packet arrival to the buffer, (2) timestamps on or within the media bearing packets, and (3) timestamps on or within the priority packets which may not include media data.

Based on information derived from the receive buffer and/or information derived from data within the received packets, a jitter assessment module may estimate a jitter level value associated with the receipt of media bearing data packets. According to some embodiments of the present invention, the jitter assessment module may intermittently calculate the derivative of the rate of packet arrival (i.e. the change in the rate at which packets arrive at media receiver). A jitter level value relating to a given period of time (e.g. 15 to 60 seconds) may be directly correlated with the derivative of the rate of packet arrivals over the given period of time.

According to some embodiments of the present invention, a jitter level value may be transmitted from the media receiver to the media transmitter, where the jitter level value may have an impact on the following operational parameters of the media transmitter: (1) encoding and/or transrating level, (2) size of the packets into which the encoded media data is packetized, and (3) rate at which packets are moved from the transmit buffer to the RF transmission unit.

According to some embodiments, the jitter level value may also be used by the media receiver to adjust the rates at which packets are moved from the receiver buffer to the depacketizer. The jitter level value may also impact the rate at which the decoder operates to reproduce the media data stream. For example, a high jitter value may result in the selection of a slower clock rate, which slower clock rate may help avoid breaks in the reproduced media data stream.

According to some embodiments of the present invention, a media transmitter/transceiver may engage in multiple communication sessions simultaneously. For Example, the media transmitter/transceiver may concurrently stream a media stream to a first media receiver/transceiver connected to a presentation device while receiving data (media file or executable code) from a second device (e.g. a computer acting as a server). This multiple concurrent communication session feature is supported by several wireless communication standards, including WiFi, each of which standards may be utilized in accordance with various embodiments of the present invention.

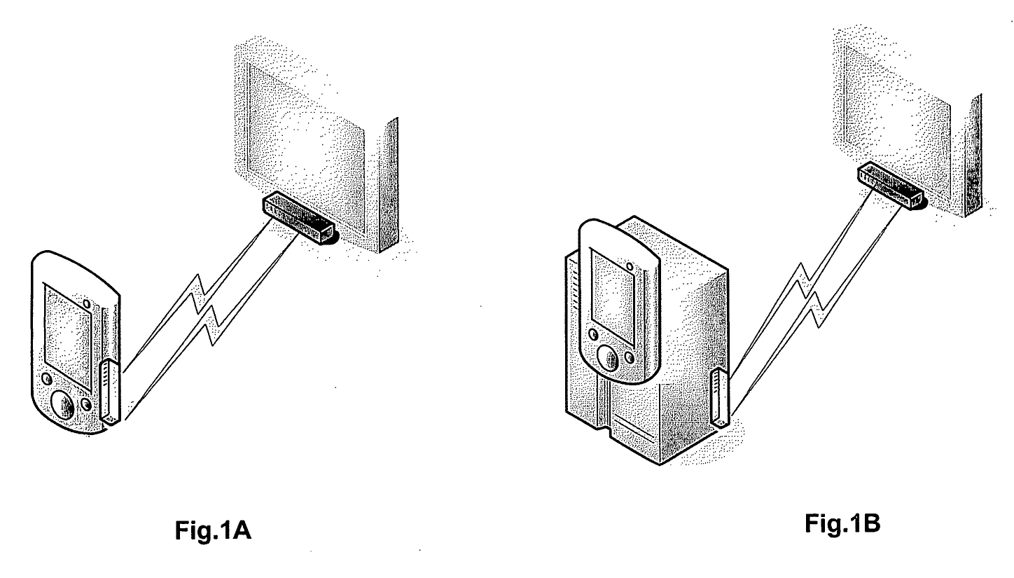

Turning now to FIG. 1A, there is shown an illustration of a mobile media/gaming device transmitting to a presentation device content bearing data through an integrated media transceiver, in according with some embodiments of the present invention. The presentation device may include an integrated or functionally associated media receiver in accordance with some embodiments of the present invention. The media transceiver and media receiver may be Radio Frequency based, utilizing one of the established RF data link technologies, for example WiFi or Bluetooth.

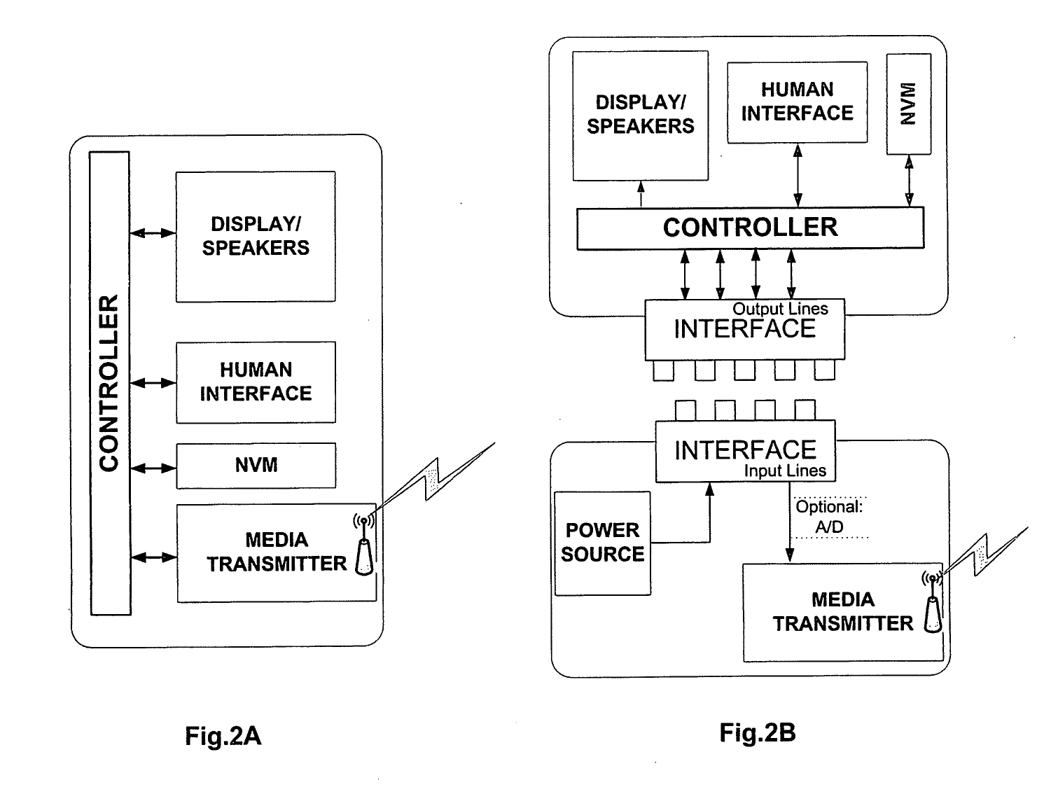

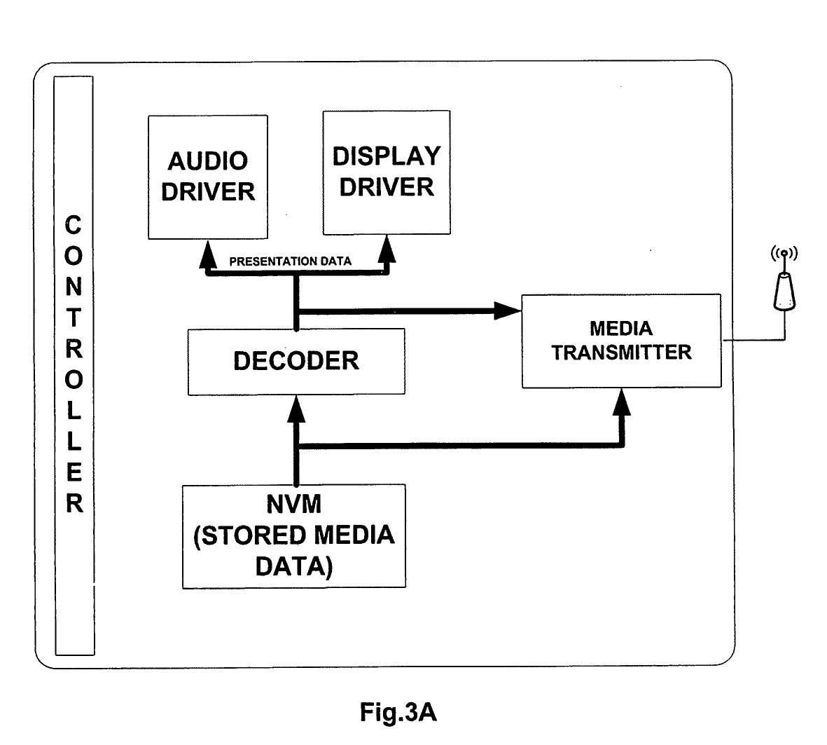

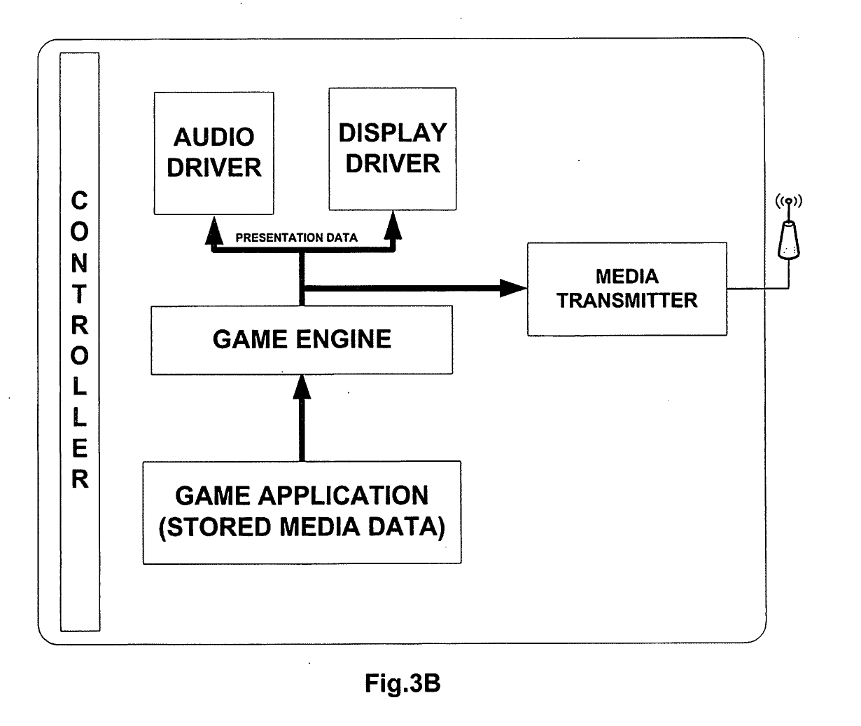

As elaborated in FIG. 2A, which figure shows a functional block diagram of mobile media/game device having an integrated media transceiver in accordance with some embodiments of the present invention, the mobile media/gaming device may also include: (1) a non-volatile memory in which media files (coded and decoded) may be stored; (2) a decoder for converting coded media files into presentation data (as shown in FIG. 3A); (3) presentation components such a display and speaker; and (4) a human interface. FIG. 3A, which shows a functional block diagram and signal flow of mobile media device including a media transceiver in accordance with some embodiments of the present invention, illustrates that the media transceiver may transmit either stored data (i.e. media files) or presentation data generated by the decoder of the mobile media device. Conversely, FIG. 3B, which shows a functional block diagram and signal flow of a mobile gaming device including a media transceiver in accordance with some embodiments of the present invention, shows that the media transceiver on the mobile gaming device might transmit only presentation data generated by a gaming engine or processor on the device.

Turning now to FIG. 1B, there is shown an illustration of a mobile media/gaming device transmitting to a presentation device content bearing data through a media transceiver integrated into a cradle within which the mobile device is docked, in according with some embodiments of the present invention. As elaborated in FIG. 2B, which figure shows a functional block diagram of mobile media/game device connectable with a cradle having an integrated media transceiver in accordance with some embodiments of the present invention, the mobile media/gaming device may include one or more output signal lines, analog or digital, which output lines may connect to the cradle through an interface plug. The cradle may include circuitry to direct the mobile media/gaming device's output lines to a media transceiver integrated with the cradle. According to some embodiments of the present invention, where the output of the mobile media/gaming device is analog, the cradle may include an analog to digital converter which may digitize the output lines'signal(s) prior to providing same to the media transceiver.

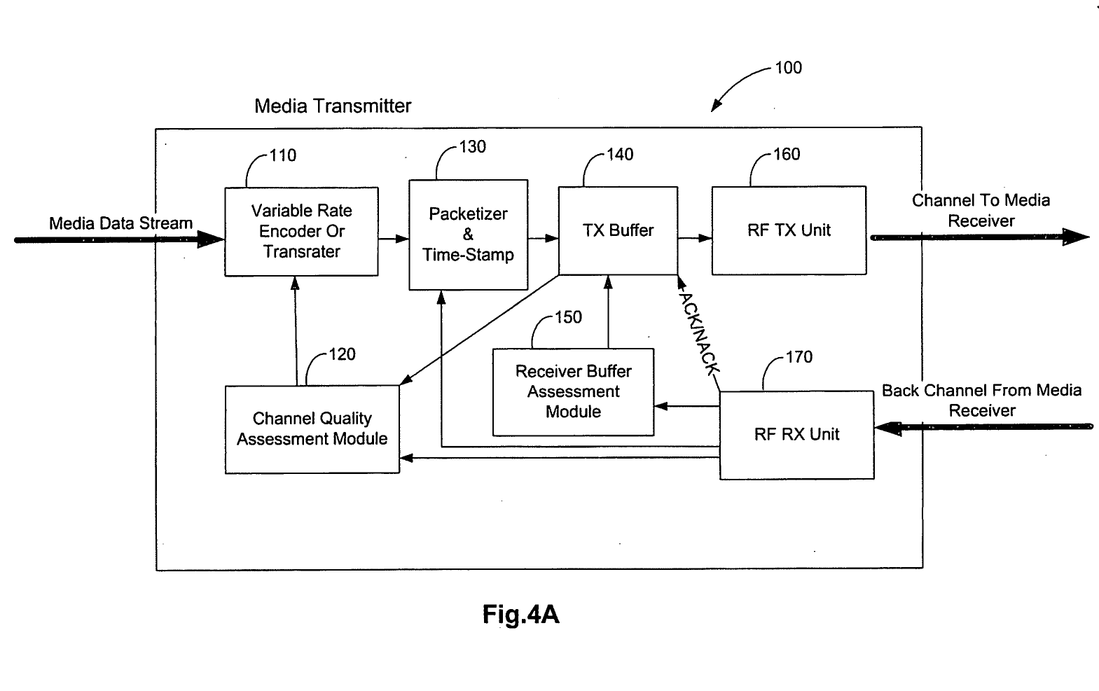

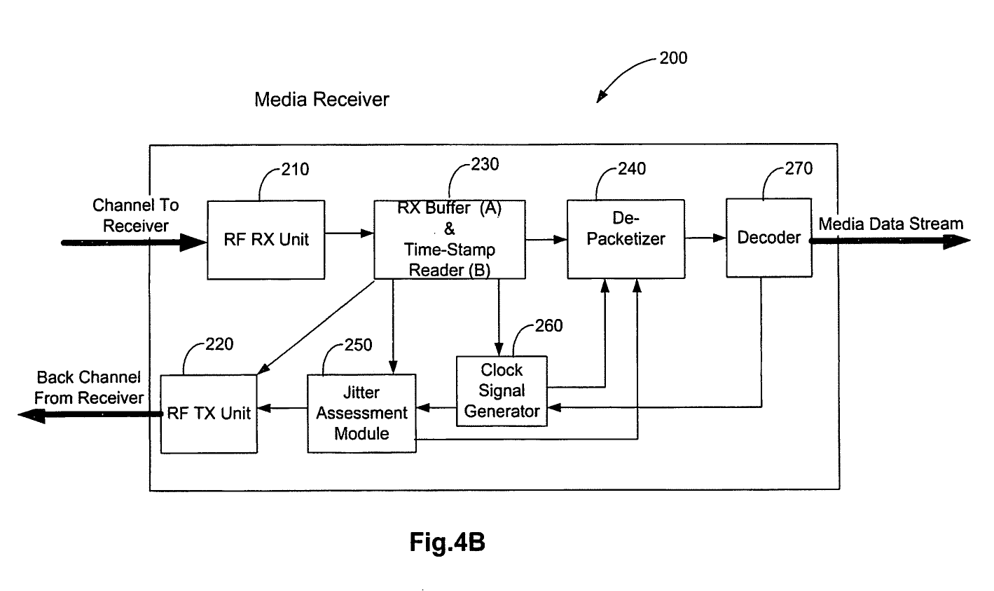

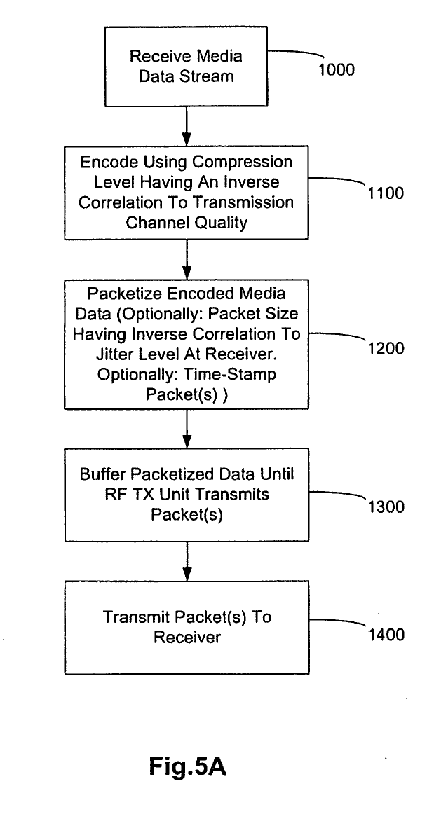

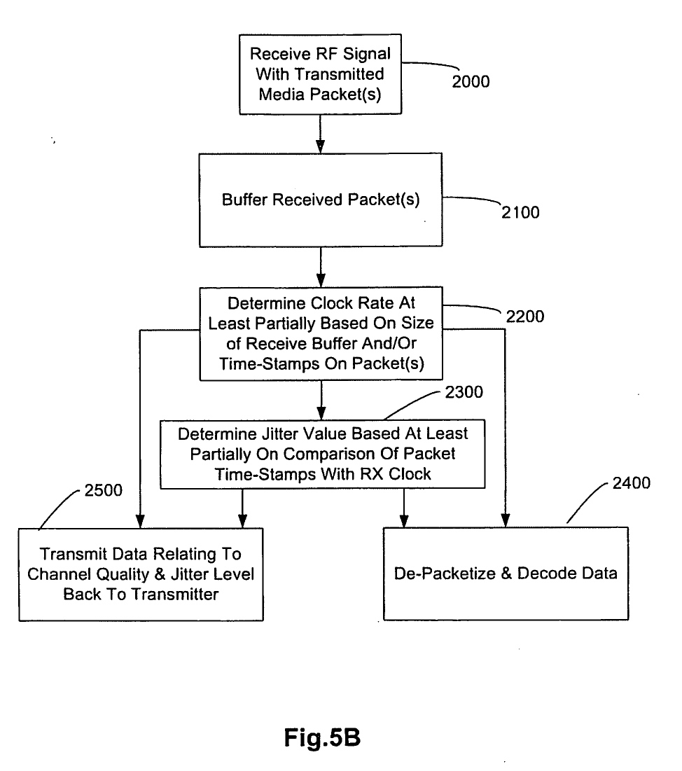

Turning now to FIG. 4A, there is shown a functional block diagram and signal flow of a media transceiver 100 in accordance with some embodiments of the present invention, the operation of which may be described in conjunction with FIG. 5A, which figure shows a flow chart including steps implemented by a media transceiver 100 in accordance with some embodiments of the present invention. The media transmitter and/or transceiver 100 may include a variable rate encoder and/or a variable rate transrater 110. A transmission channel quality assessment module 120 may cause the variable rate encoder and/or transrater 110 to encode a media/gaming related data stream (step 1100) using a compression level having an inverse correlation to the transmission channel quality of the channel over which the media transmitter and/or transceiver transmits. According to some embodiments of the present invention, the encoder and/or transrater 110 may add a time-stamp to the encoded data.

According to further embodiments of the present invention, a packetizer 130 may packetize the encoded data (step 1200). The packetizer 130 may packetize the encoded data into one or more packets whose size may have an inverse correlation to a jitter level at a media receiver 200. Additionally, the packetizer 130 may intermittently produce one or more high priority data packet(s) whose primary payload is a time-stamp, and which time-stamp carrying packet(s) may include little or no content bearing data. High priority packet(s) with the time-stamp payload may be used by a media receiver 200 to estimate a clock rate of the media stream entering the media transmitter and to generate a clock signal at the receiver corresponding to the estimated rate (i.e. reconstruct the media stream clock).

According to some embodiments of the present invention, the media transmitter may include a transmit buffer 140 (e.g. First In First Out—“FIFO”) to temporarily store one or more packets (step 1300) before the one or more packets are transmitted (step 1400) by a RF transmitting unit 160 (e.g. a WiFi Radio, a Bluetooth Radio, etc.). According to further embodiments of the present invention, the buffer 140 may reduce the rate at which it provides packets to the RF transmitting unit 160 when a receiver buffer assessment unit 150, which receives receiver buffer size information via a back channel, determines and indicates that a buffer on the Media Receiver is storing a volume of data exceeding some capacity level of the receive buffer (e.g. 70% of the buffers fully data storage capacity).

The transmit buffer 140 may also store for some predefined period of time packets which have already been transmitted by the RF transmit unit 160. According to these embodiments of the present invention, the predefined period of time may be of a slightly greater duration than a time-out period defined by an RF receiver to which the packet is to be transmitted. Should the transmit buffer 140 receive an indication from the RF receiver that the RF receiver has not received a specific packet within the predefined time-out period (i.e. either does not receive an “Acknowledged Signal” (“ACK”) or receives a “Not Acknowledged Signal” (“NACK”) from the RF receiver), the transmit buffer 140 may resubmit the specific non-received packet to the RF transmit unit 160 for retransmission.

Turning now to FIG. 4B, there is shown a functional block diagram and signal flow of a media receiver 200 according to some embodiments of the present invention, the operation of which may be described in conjunction with FIG. 5B, which figure shows a flow chart including steps implemented by a media receiver in accordance with some embodiments of the present invention.

A media receiver or media transceiver 200 functionally associated with a presentation device may receive media related data (step 2000) transmitted by the media transmitter or transceiver 100 functionally associated with the mobile media/gaming device. The media receiver/transceiver 200 may include a RF receiver unit 210, a receiver buffer 230A for buffering received packets (steps 2100), a time-stamp reader 230B, a clock recovery unit 260 and a jitter assessment unit 250. The clock recovery unit 260 may derive a clock rate (step 2200) and may generate a clock signal associated the media content bearing data stream based on several factors including: (1) rate of packet arrival to the buffer, (2) timestamps on or within the media bearing packets, and (3) timestamps on or within the priority packets which may not include media data.

Based on information derived from the receive buffer and/or information derived from data within the received packets, a jitter assessment module 250 may estimate a jitter level value (step 2300) associated with the receipt of media bearing data packets. According to some embodiments of the present invention, the jitter assessment module 250 may intermittently calculate the derivative of the rate of packet arrival (i.e. the change in the rate at which packets arrive at media receiver) A jitter level value relating to a given period of time (e.g. 15 to 60 seconds) may be directly correlated with the derivative of the rate of packet arrivals over the given period of time.

According to some embodiments of the present invention, a jitter level value may be transmitted (step 2500) from the media receiver to the media transmitter, where the jitter level value may have an impact on the following operational parameters of the media transmitter: (1) encoding and/or transrating level, (2) size of the packets into which the encoded media data is packetized, and (3) rate at which packets are moved from the transmit buffer to the RF transmission unit.

According to some embodiments, the jitter level value may also be used by the media receiver to adjust the rates at which packets are moved from the receiver buffer to the depacketizer 240 (step 2400). The jitter level value may also impact the rate at which the decoder 270 operates to reproduce the media data stream (step 2400).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A mobile media/gaming apparatus comprising: a media transmitter adapted to transmit on a transmission channel data packets with content data to a media receiver functionally associated with a presentation device, said media transmitter comprising real-time video streaming circuitry.

2. The mobile media/gaming apparatus according to claim 1, wherein said real-time video streaming circuitry comprises a variable rate encoder/transrater adapted to encode/transrate media data at a compression level inversely correlated to a quality value associated with the transmission channel.

3. The mobile media/gaming apparatus according to claim 2, wherein said encoder/transrater if further adapted to apply a timestamp to the encoded/transrated media data.

4. The mobile media/gaming apparatus according to claim 2, wherein said real-time video streaming circuitry further comprises a channel quality assessment module adapted to quality value associated with the transmission channel based on one or more factors selected from the group consisting of transmit buffer size, receive buffer size, jitter level, signal-to-noise ratio, packet error rate, and packet latency.

5. The mobile media/gaming apparatus according to claim 2, wherein said real-time video streaming circuitry comprises a packetizer adapted to packetize the encoded/transrated media data.

6. The mobile media/gaming apparatus according to claim 5, wherein said packetizer is adapted to insert a timestamp into one or more packets.

7. The mobile media/gaming apparatus according to claim 5, wherein said packetizer is adapted to packetize the encoded/transrated media data into one or more packets whose size is inversely correlated to a jitter level.

8. The mobile media/gaming apparatus according to claim 5, further comprising a transmit buffer adapted to store and provide packets to a Radio Frequency Transmit Unit (“RF TX Unit”).

9. The mobile media/gaming apparatus according to claim 8, wherein said transmit buffer is adapted to resubmit a given packet to the RF TX Unit if the given packet is not received within some predefined period of time.

10. The mobile media/gaming apparatus according to claim 1, wherein said media transmitter is adapted to transmit at a relatively higher power level when said device is connected to an external power source.

11. The mobile media/gaming apparatus according to claim 1, wherein said media transmitter is adapted to engage in multiple concurrent communication sessions with two or more devices.

12. A cradle for a mobile media apparatus comprising: a media transmitter adapted to receive content bearing data from the mobile media device and to transmit data packets with the content data to a media receiver functionally associated with a presentation device, said media transmitter comprising real-time video streaming circuitry.

13. The cradle according to claim 12, wherein said real-time video streaming circuitry comprises a variable rate encoder/transrater adapted to encode/transrate media data at a compression level inversely correlated to a quality value associated with the transmission channel.

14. The cradle according to claim 13, wherein said encoder/transrater if further adapted to apply a timestamp to the encoded/transrated media data.

15. The cradle according to claim 13, wherein said real-time video streaming circuitry further comprises a channel quality assessment module adapted to quality value associated with the transmission channel based on one or more factors selected from the group consisting of transmit buffer size, receive buffer size, jitter level, signal-to-noise ratio, packet error rate, and packet latency.

16. The cradle according to claim 13, wherein said real-time video streaming circuitry comprises a packetizer adapted to packetize the encoded/transrated media data.

17. The cradle according to claim 16, wherein said packetizer is adapted to insert a timestamp into one or more packets.

18. The cradle according to claim 16, wherein said packetizer is adapted to packetize the encoded/transrated media data into one or more packets whose size is inversely correlated to a jitter level.

19. The cradle according to claim 16, further comprising a transmit buffer adapted to store and provide packets to a Radio Frequency Transmit Unit (“RF TX Unit”).

20. The cradle according to claim 19, wherein said transmit buffer is adapted to resubmit a given packet to the RF TX Unit if the given packet is not received within some predefined period of time.

21. The cradle according to claim 19, wherein said transmit buffer is adapted to reduce a rate at which it provides packets to the RF TX Unit if it receives an indication that a receive buffer is filled beyond a predefined level.

22. The cradle according to claim 12, wherein said media transmitter is adapted to engage in multiple concurrent communication sessions with two or more devices.
